(19) United States
(12) Patent Application Publication
(10) Pub. No.: US 2015/0062706 A1
(43) Pub. Date: Mar. 5, 2015

(54) LENS DRIVING DEVICE AND CAMERA MODULE INCLUDING THE SAME

(71) Applicant: SAMSUNG ELECTRO-MECHANICS CO., LTD., Suwon (KR)

(72) Inventors: Soo Cheol Lim, Suwon (KR); Sung Ryung Park, Suwon (KR); Chul Jin Kim, Suwon (KR); Byung Woo Kang, Suwon (KR); Sang Min On, Suwon (KR)

(73) Assignee: SAMSUNG ELECTRO-MECHANICS CO., LTD., Suwon (KR)

(21) Appl. No.: 14/086,901

(22) Filed: Nov. 21, 2013

(30) Foreign Application Priority Data
Aug. 27, 2013 (KR) 10-2013-0101843

(51) Int. Cl. G02B 7/09; G02B 27/64

(52) U.S. Cl. CPC G02B 7/09; G02B 27/646; G02B 7/026
USPC 359/554; 359/824

(57) ABSTRACT

There is provided a lens driving device, including: an auto-focusing driving unit disposed between a first frame supporting a lens in an optical axis direction and a second frame having a first gap with respect to the first frame; a camera shake stabilizing unit disposed between the second frame and an outer portion having a second gap with respect to the second frame; a leaf spring connected to the first and second frames to maintain the lens on a plane perpendicular to the optical axis direction, the leaf spring having a free-bent edge portion; and a suspension wire disposed in the optical axis direction, wherein one end of the suspension wire is fixed to the edge portion and the other end is fixed to the outer portion so that the second frame is floated from the outer portion.

### CROSS-REFERENCE TO RELATED APPLICATIONS

This application claims the priority of Korean Patent Application No. 10-2013-0101843 filed on Aug. 27, 2013, in the Korean Intellectual Property Office, the disclosure of which is incorporated herein by reference.

### BACKGROUND

The present disclosure relates to a lens driving device for a camera in a mobile communication terminal, and a camera module including the same.

Recently, mobile phones such as smartphones, and mobile communication terminals such as tablet PCs and laptop computers have been equipped with high performance micro cameras.

The smaller the mobile communication terminal is, the more it is influenced by camera shake caused by unstable user hand movements in capturing an image, and thus the quality of the image may be deteriorated. Therefore, required is a technique for compensating for camera shake to obtain a clear image.

If a camera shakes when a user is capturing an image, in order to compensate for camera shake, a lens driving device employing optical image stabilization (OIS) may be used.

Generally, the OIS technique compensates for the misalignment of the light passing through a lens when it is offset from the optical axis. Accordingly, the lens driving device employing the OIS technique compensates for camera shake by way of moving a lens in a direction perpendicular to the optical axis direction to align the optical axis with a path of incident light, or by way of moving an image sensor in the direction perpendicular to the optical axis direction to align the optical axis with an incident path of light received by the image sensor.

In other words, the OIS technique compensates for camera shake by applying relative displacement to the lens and the image sensor in the direction perpendicular to the optical axis direction, i.e., the axes directions (X-Y direction) crossing the optical axis direction (Z direction).

The lens driving device employing the OIS technique may include a leaf spring that is formed in the X-Y direction and attenuates the deformation of a lens barrel, and a suspension wire that is formed in the Z direction and supports the leaf spring.

Patent Document 1 discloses that wires linearly extending in the optical axis direction and a buckling prevention member (wire fixing parts 8d and 9b and a contact member 21) which is elastically deformed in the optical axis direction with a force smaller than the buckling load of the wires in order to prevent the buckling of the wires are formed on the bottom surface of a leaf spring or a fixture. Patent Document 2 discloses that wires are inclined so that upper end sides of the wires are widened with respect to lower end sides thereof, and thus tilt of the lens in the optical axis direction is suppressed during compensation on the X-Y plane.

However, Patent Documents 1 and 2 do not disclose the structure in which a coupling portion of the lead spring to which a suspension wire is coupled is free-bent in the optical axis direction in order to suppress tilt of the lens.

### RELATED ART DOCUMENTS

(Patent Document 1) Japanese Patent Laid-open Publication No. 2011-113009
(Patent Document 2) Japanese Patent Laid-open Publication No. 2011-133702

### SUMMARY

An aspect of the present disclosure provides a lens driving device capable of reducing a tilt of a lens, and a camera module including the same.

According to an aspect of the present disclosure, there is provided a lens driving device including: an auto-focusing driving unit disposed between a first frame supporting a lens in an optical axis direction and a second frame having a first gap with respect to the first frame; a camera shake stabilizing unit disposed between the second frame and an outer portion having a second gap with respect to the second frame; a leaf spring connected to the first and second frames to maintain the lens on a plane perpendicular to the optical axis direction, the leaf spring having a free-bent edge portion; and a suspension wire disposed in the optical axis direction, wherein one end of the suspension wire is fixed to the edge portion and the other end is fixed to the outer portion so that the second frame is floated from the outer portion.

The auto-focusing driving unit may include a coil disposed on the first frame and a magnet disposed on the second frame, and the camera shake stabilizing unit may include a magnet disposed on the second frame and a coil disposed on the outer portion.

The outer portion may include a shield case, in which the shield case may include a hall sensor on its inner upper surface corresponding to the magnet disposed on the second frame in the optical axis direction, the hall sensor detecting displacement in a direction perpendicular to the optical axis direction.

The edge portion may include a hole-like wire coupling portion into which a tip of the suspension wire is inserted, in which the wire coupling portion and the tip of the suspension wire may be coupled to each other by soldering.

The edge portion may have a hole so that the wire coupling portion is formed as a strip band portion.

The edge portion may be bent upwardly in the optical axis direction.

The edge portion may be bent downwardly in the optical axis direction.

The second frame may have a rounded, receiving groove therein to prevent contact with the suspension wire.

The leaf spring may include an upper leaf spring fixed to upper surfaces of the first and second frames and a lower leaf spring fixed to lower surfaces of the first and second frames, and the leaf spring may include a coupling hole into which projections formed on the first and second frames are inserted to be coupled thereto.

The second frame may include a positioning projection to guide a coupling position of the leaf spring, in which the leaf spring may include a contacting portion in contact with the positioning projection.

According to another aspect of the present disclosure, there is provided a camera lens module including: a first frame supporting a lens and having a coil disposed on its outer surface; a second frame supporting a magnet disposed outside of the coil and moving the lens in an optical axis direction by interacting with the coil; an outer portion including the second frame therein and having a coil that interacts with the magnet so as to maintain the lens on the plane perpendicular to the optical axis direction; a leaf spring connected to the first frame and the second frame to maintain the lens on the plane perpendicular to the optical axis direction and having a free-bent edge portion; and a suspension wire disposed in the optical axis direction and fixed to the edge portion and the outer portion so that the second frame is floated from the outer portion.

The edge portion may include a hole-like wire coupling portion into which a tip of the suspension wire is inserted, in which the wire coupling portion and the tip of the suspension wire may be coupled to each other by soldering.

The edge portion may have a hole so that the wire coupling portion is formed as a strip band portion.

The second frame may have a rounded, receiving groove therein to prevent contact with the suspension wire.

The leaf spring may include an upper leaf spring fixed to upper surfaces of the first and second frames and a lower leaf spring fixed to lower surfaces of the first and second frames, and the leaf spring may include a coupling hole into which projections formed on the first and second frames are inserted to be coupled thereto.

The second frame may include a positioning projection to guide a coupling position of the leaf spring, in which the upper leaf spring may include a contacting portion in contact with the positioning projection.

The outer portion may include a shield case, in which the shield case may include a hall sensor on its inner upper surface corresponding to the magnet in the optical axis direction, the hall sensor detecting displacement in a direction perpendicular to the optical axis direction.

The edge portion may be bent upwardly in the optical axis direction.

The edge portion may be bent downwardly in the optical axis direction.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a cut-away perspective view of a camera module according to an embodiment of the present disclosure;

FIG. 2 is an exploded perspective view of the camera module according to the embodiment of the present disclosure;

FIG. 3 is a perspective view of the lens driving device installed in the camera module according to the embodiment of the present disclosure;

FIG. 4 is an exploded perspective view of the lens driving device installed in the camera module according to the embodiment of the present disclosure;

FIG. 5 is a perspective view of the outer portion of the camera module according to the embodiment of the present disclosure;

FIG. 6 is a cross-sectional view of the camera module shown in FIG. 1 taken along line VI-VI;

FIG. 7 is a plan view of the camera module with the outer portion removed;

FIG. 8 is a perspective view of the suspension wire coupled to the leaf spring according to the first embodiment;

FIG. 9 is a perspective view of the suspension wire coupled to the leaf spring according to the second embodiment; and

FIG. 10 is an enlarged view of part A in FIG. 3 according to another embodiment.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

### Camera Module and Lens Driving Device

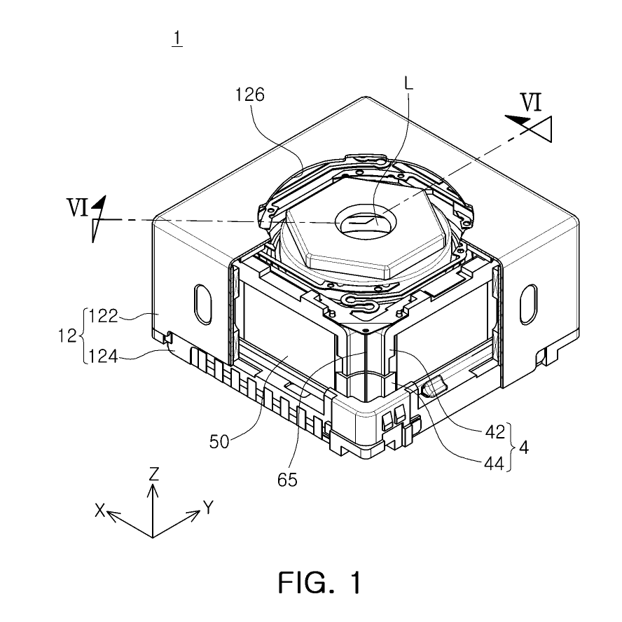

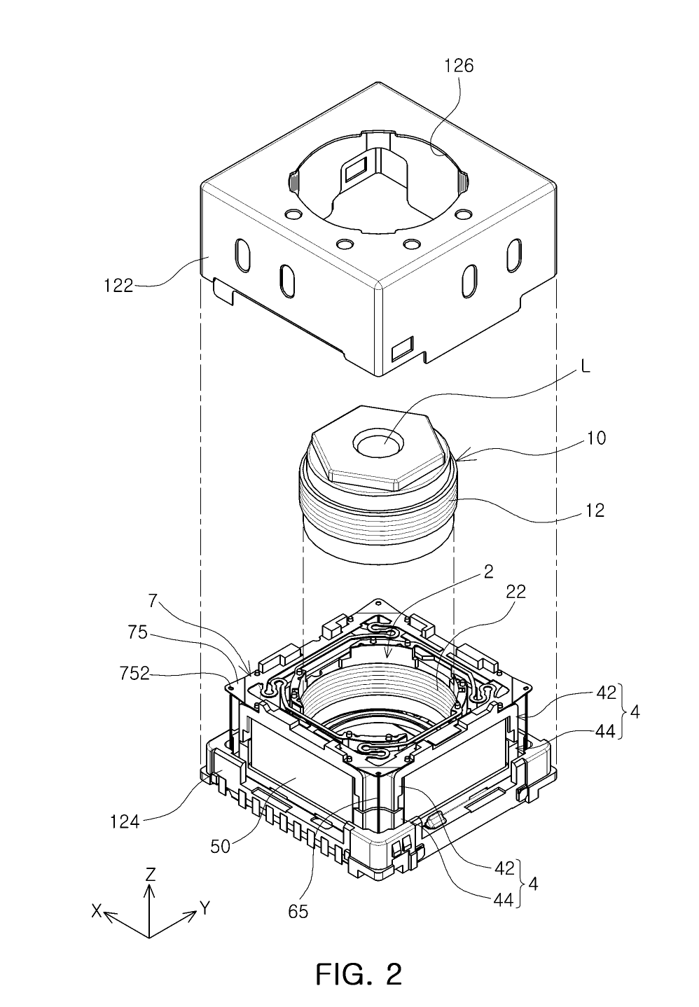

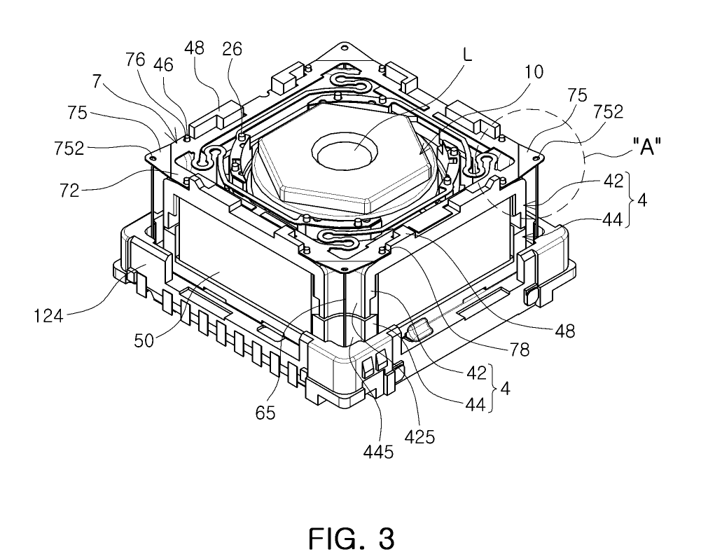

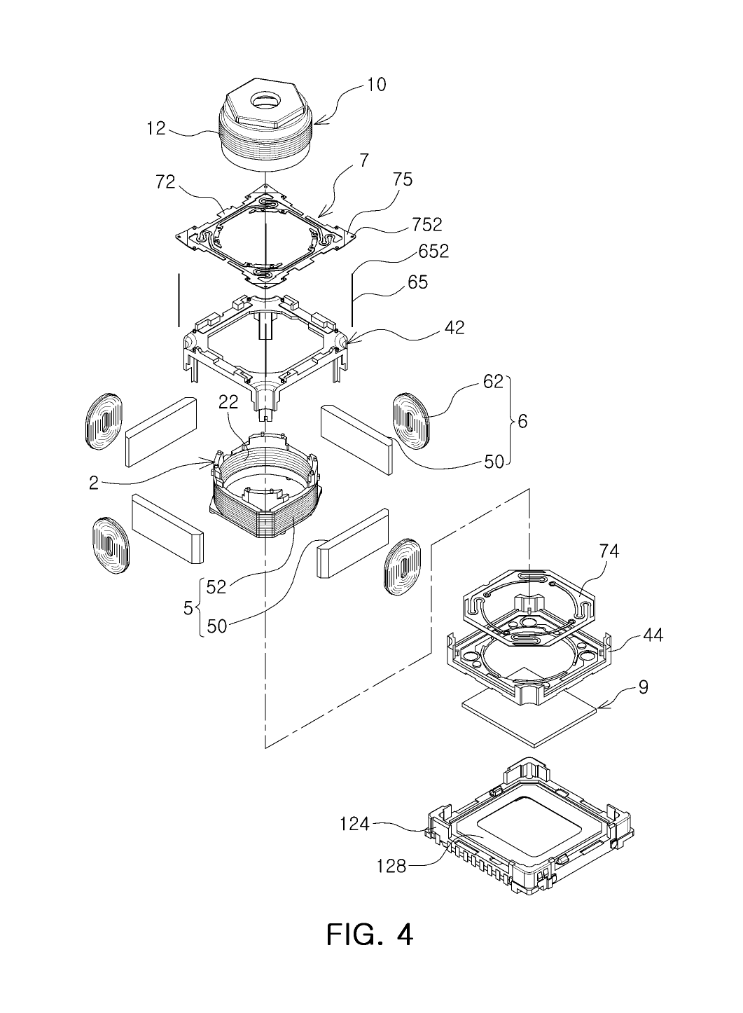

FIG. 1 is a cut-away perspective view of a camera module according to an embodiment of the present disclosure, and FIG. 2 is an exploded perspective view of the camera module according to the embodiment of the present disclosure. FIG. 3 is a perspective view of the lens driving device installed in the camera module according to the embodiment of the present disclosure; and FIG. 4 is an exploded perspective view of the lens driving device installed in the camera module according to the embodiment of the present disclosure.

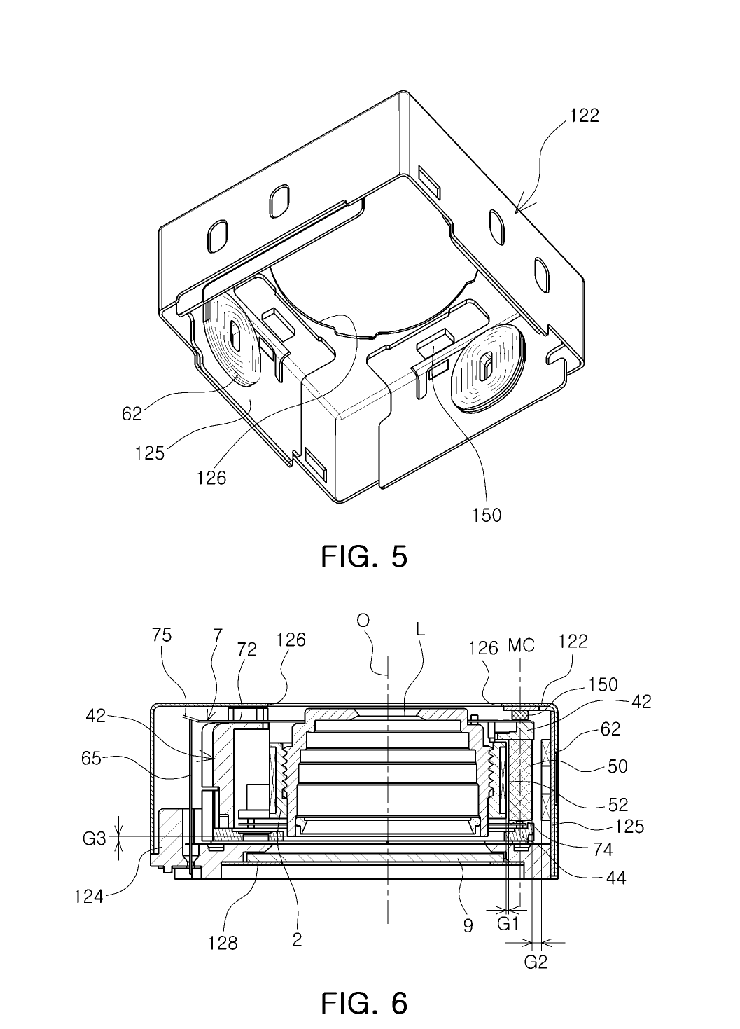

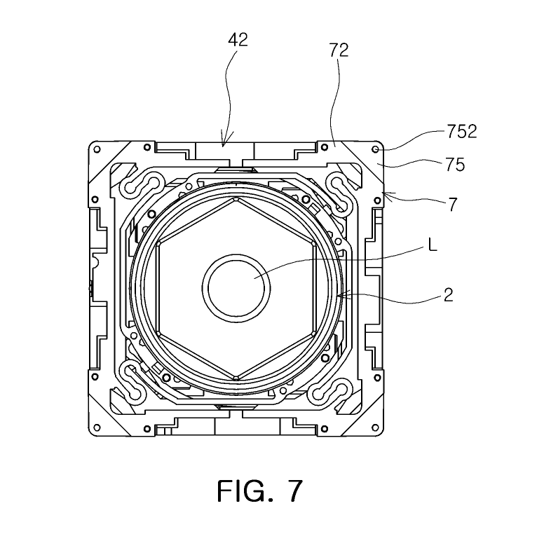

FIG. 5 is a perspective view of the outer portion of the camera module according to the embodiment of the present disclosure; FIG. 6 is a cross-sectional view of the camera module shown in FIG. 1 taken along line VI-VI; and FIG. 7 is a plan view of the camera module with the outer portion removed.

Referring to FIGS. 1 to 7, the camera module 1 according to an embodiment of the present disclosure includes a first frame 2, a second frame 4, an outer portion 12, a leaf spring 7, and a suspension wire 65.

First of all, let us define the directions of the camera module for the sake of clarity in describing embodiments of the present disclosure. In FIG. 2, the Z direction refers to the optical axis direction in which light travels in a direction perpendicular to a lens L, the X direction and Y direction refer to the directions defining the plane (X-Y plane) orthogonal to the optical axis direction.

The first frame 2 may have a cylindrical shape and may have a lens barrel 10 to support a lens L or a group of lenses inserted therein and fixed to its inner peripheral surface. An auto-focusing driving unit 5 may be disposed between the first frame 2 and a second frame 4.

The auto-focusing driving unit 5 may move the lens L in the optical axis direction so as to make an image produced on an image sensor 9 (in FIG. 4) clear. The auto-focusing driving unit 5 may move the lens barrel 10 in the vertical direction and may include a voice coil motor (VCM) type that uses electromagnetic force between a coil and a magnet, an ultrasonic motor type that uses a piezo element, a type that applies current to a wire in a memory alloy, and the like.

In the embodiment, the lens L is moved in the optical axis direction to auto-focus by the electromagnetic force between a coil 52 formed on the outer peripheral surface of the first frame 2 and a magnet 50 supported by the second frame 4 with a first gap G1 therebetween.

Between the second frame 4 and the outer portion 12, a camera shake stabilizing unit 6 may be provided.

The camera shake stabilizing unit 6 serves to compensate for image blur or shaking of a video image caused when a user's hand shakes.

Similarly to the auto-focusing driving unit 5, the camera shake stabilizing unit 6 is not specifically limited as long as it is able to move the lens L in the X-Y direction.

In the embodiment, the camera shake stabilizing unit 6 may move the lens L in the X-Y direction by using the magnet 50 supported by the second frame 4 and a coil 62 formed on the outer portion 12.

The magnet 50 supported by the second frame 4 may correspond to the coil 62 supported on the outer portion 12 with a second gap G2.

The first gap G1 and the second gap G2 are initially parallel to the optical axis direction, but deviate due to camera shake when capturing images. That is, the first frame 2 supporting the lens L has a deviation in the X-Y direction, and the lens L is tilted. The camera shake stabilizing unit 6 may move the first and second frames 2 and 4 in the X-Y direction in order to compensate for a tilt of the lens L.

Here, the magnet 50 supported by the second frame 4 may not only move the coil 52 formed on the outer peripheral surface of the first frame 2 but may also move the lens L in the X-Y direction. The magnetization direction of the surface of the magnet 50 facing the coil 52 formed on the first frame 2 may be different from the magnetization direction of the surface of the magnet 50 facing the coil 62 formed on the outer portion 12.

In order to compensate for the deviation of the lens L in the X-Y direction, the second frame 4 needs to be supported on the upper surface of the lower frame 124 of the outer portion 12 with a third gap G3.

The first frame 2 and the second frame 4 may be supported by the leaf spring 7.

The leaf spring 7 may be connected to the first frame 2 and the second frame 4 such that the lens L is maintained on the plane perpendicular to the optical axis direction.

The leaf spring 7 may include an upper leaf spring 72 fixed to the upper surfaces of the first and second frames 2 and 4, and a lower leaf spring 74 fixed to the lower surfaces of the first and second frames 2 and 4.

The leaf spring 7 may include coupling holes 76 into which projections 26 and 46 formed on the first and second frames 2 and 4 are inserted.

The leaf spring 7 and the second frame 4 may include a further coupling means in order to be more securely and easily coupled to each other.

Specifically, the second frame 4 may have a positioning projection 48 to guide the leaf spring 7 to the position to which it is to be coupled. In addition, the leaf spring 7 may have a contacting portion 78 in contact with the positioning projection 48 to guide the position of the leaf spring 7.

The leaf spring 7 has free-bent edge portions 75 at its four edges. The free bent edge portions 75 may reduce a tilt amount in the optical axis direction O of the lens L significantly, compared to non-bent, flat edge portions.

The outer portion 12 features the outer appearance of the camera module 1 and may include a shield case 122 to block electromagnetic waves and a lower frame 124 coupled to the shield case 122.

The shield case 122 has an opening 126 through which a lens is exposed in the optical axis direction O.

In addition, the shield case 122 may have a flexible circuit board 125 attached on its inner surface, and the coil 62 (in FIG. 5) supplied with current from the flexible circuit board 125 may be fixed thereon.

Further, the shield case 122 may have a hall sensor 150 formed on its inner upper surface to detect displacement on the X-Y plane of the lens L.

The hall sensor 150 may be installed so as to substantially correspond, in the optical axis direction O, to the center MC of the magnet 50 fixed to the second frame 4. A change in magnetic field is directly detected at the center MC of the magnet 50, so that the camera shake stabilizing unit 6 may be quickly moved.

Incidentally, the second frame 4 may be divided into an upper frame 42 and a lower frame 44.

The second frame 4 needs to be supported such that it has the third gap G3 with the upper surface of the lower frame 124 of the outer portion 12 in the optical axis direction.

The suspension wire 65 is fixed to the edge portion 75 of the second frame 4 and to the lower frame 124 of the outer portion in order to support the second frame 4 so that it has the third gap G3 with the upper surface of the lower frame 124 of the outer portion 12.

The suspension wire 65 may be parallel in the optical axis direction with no curve.

In order to prevent the suspension wire 65 from being deformed to be in contact with the second frame 4, the second frame 4 may have rounded receiving grooves 425 and 445.

The receiving grooves 425 and 445 may prevent the suspension wire 65 from being deformed by impact applied when the camera module 1 falls down or the like.

### Suspension Wire Coupled to Leaf Spring

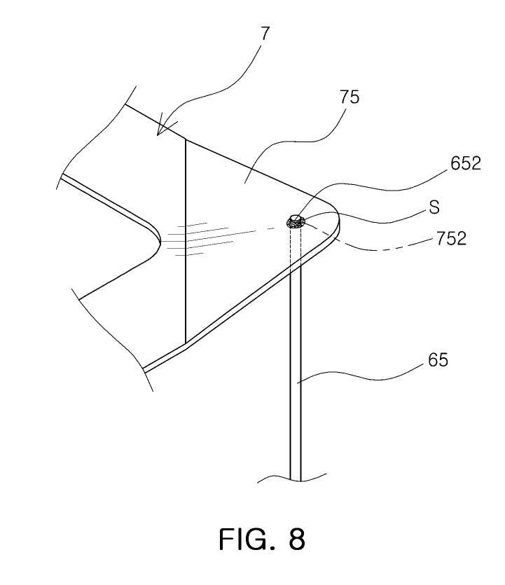

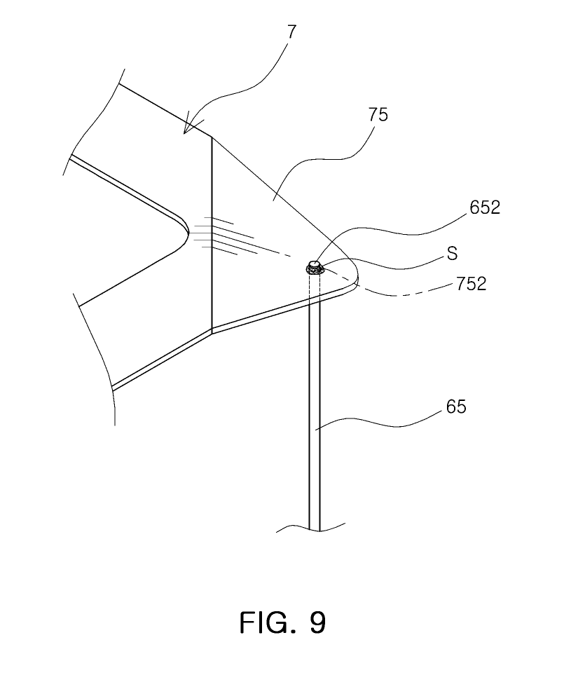

FIG. 8 is a perspective view of the suspension wire coupled to the leaf spring according to the first embodiment, and FIG. 9 is a perspective view of the suspension wire coupled to the leaf spring according to the second embodiment.

Referring to the embodiment in FIG. 8, the edge part 75 of the leaf spring 7 is free-bent upwardly in the optical axis direction, and the tip 652 of the suspension wire 65 is coupled to the edge portion 75.

The edge portion 75 may have a hole-like, wire coupling portion 752 into which the tip 652 of the suspension wire 65 is inserted to be coupled thereto. The wire coupling portion 752 and the tip 652 may be securely coupled to each other by soldering S.

Referring to the embodiment in FIG. 9, the edge part 75 of the leaf spring 7 is free-bent downwardly in the optical axis direction, and the tip 652 of the suspension wire 65 is coupled to the edge portion 75.

The edge portion 75 may have a hole-like, wire coupling portion 752 into which the tip 652 of the suspension wire 65 is inserted to be coupled thereto. Like in the embodiment shown in FIG. 8, the wire coupling portion 752 and the tip 652 may be securely coupled to each other by soldering S.

By free-bending the edge portion 75 of the leaf spring 7 upwardly or downwardly in the optical axis direction, a tilt of the lens L is significantly reduced compared to a flat edge portion even if a camera shakes. Further, displacement in the X-Y direction can be quickly adjusted by the camera shake stabilizing unit 6, to thereby obtain a clear image.

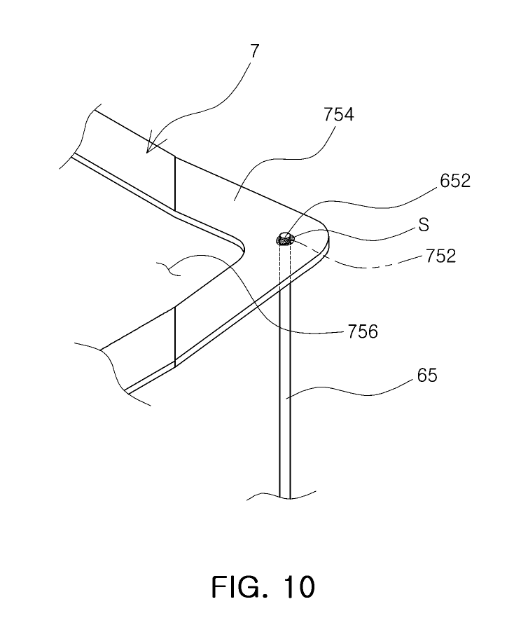

FIG. 10 is an enlarged view of part A in FIG. 3 according to another embodiment.

Referring to FIG. 10, space 756 is provided in the free bent edge portion 75 such that the free bent edge portion 75 of the leaf spring 7 has a strip shape.

By virtue of the space 756, the edge portion 75 becomes more elastic so that a tilt of the lens L can be prevented even if impact is applied or large displacement is made on the X-Y plane.

As set forth above, with the lens driving device and the camera module including the same according to the embodiments of the present disclosure, a tilt of a lens in the optical axis direction can be significantly reduced.

While the present disclosure has been shown and described in connection with the embodiments, it will be apparent to those skilled in the art that modifications and variations can be made without departing from the spirit and scope of the disclosure as defined by the appended claims.

What is claimed is:

1. A lens driving device comprising:
an auto-focusing driving unit disposed between a first frame supporting a lens in an optical axis direction and a second frame having a first gap with respect to the first frame;
a camera shake stabilizing unit disposed between the second frame and an outer portion having a second gap with respect to the second frame;
a leaf spring connected to the first and second frames to maintain the lens on a plane perpendicular to the optical axis direction, the leaf spring having a free-bent edge portion; and
a suspension wire disposed in the optical axis direction, wherein one end of the suspension wire is fixed to the edge portion and the other end is fixed to the outer portion so that the second frame is floated from the outer portion.

2. The lens driving device of claim 1, wherein the auto-focusing driving unit includes a coil disposed on the first frame and a magnet disposed on the second frame, and
wherein the camera shake stabilizing unit includes a magnet disposed on the second frame and a coil disposed on the outer portion.

3. The lens driving device of claim 2, wherein the outer portion includes a shield case, wherein the shield case includes a hall sensor on its inner upper surface corresponding to the magnet disposed on the second frame in the optical axis direction, the hall sensor detecting displacement in a direction perpendicular to the optical axis direction.

4. The lens driving device of claim 1, wherein the edge portion includes a hole-like wire coupling portion into which a tip of the suspension wire is inserted, wherein the wire coupling portion and the tip of the suspension wire are coupled to each other by soldering.

5. The lens driving device of claim 4, wherein the edge portion has a hole such that the wire coupling portion is formed on a strip band part.

6. The lens driving device of claim 1, wherein the edge portion is bent upwardly in the optical axis direction.

7. The lens driving device of claim 1, wherein the edge portion is bent downwardly in the optical axis direction.

8. The lens driving device of claim 1, wherein the second frame has a rounded, receiving groove therein to prevent contact with the suspension wire.

9. The lens driving device of claim 1, wherein the leaf spring includes an upper leaf spring fixed to upper surfaces of the first and second frames and a lower leaf spring fixed to lower surfaces of the first and second frames, and
wherein the leaf spring includes a coupling hole into which projections formed on the first and second frames are inserted to be coupled thereto.

10. The lens driving device of claim 1, wherein the second frame includes a positioning projection to guide a coupling position of the leaf spring, wherein the leaf spring includes a contacting portion in contact with the positioning projection.

11. A camera lens module comprising:
a first frame supporting a lens and having a coil disposed on its outer surface;
a second frame supporting a magnet disposed outside of the coil and moving the lens in an optical axis direction by interacting with the coil;
an outer portion including the second frame therein and having a coil that interacts with the magnet so as to maintain the lens on the plane perpendicular to the optical axis direction;
a leaf spring connected to the first frame and the second frame so as to maintain the lens on the plane perpendicular to the optical axis direction and having a free-bent edge portion; and
a suspension wire disposed in the optical axis direction and fixed between the edge portion and the outer portion so that the second frame is floated from the outer portion.

12. The camera lens module of claim 11, wherein the edge portion includes a hole-like wire coupling portion into which a tip of the suspension wire is inserted, wherein the wire coupling portion and the tip of the suspension wire are coupled to each other by soldering.

13. The camera lens module of claim 12, wherein the edge portion has a hole so that the wire coupling portion is formed as a strip band portion.

14. The camera lens module of claim 11, wherein the second frame has a rounded, receiving groove therein to prevent contact with the suspension wire.

15. The camera lens module of claim 11, wherein the leaf spring includes an upper leaf spring fixed to upper surfaces of the first and second frames and a lower leaf spring fixed to lower surfaces of the first and second frames, and
wherein the leaf spring includes a coupling hole into which projections formed on the first and second frames are inserted to be coupled thereto.

16. The camera lens module of claim 15, wherein the second frame includes a positioning projection to guide a coupling position of the upper leaf spring, wherein the upper leaf spring includes a contacting portion in contact with the positioning projection.

17. The camera lens module of claim 11, wherein the outer portion includes a shield case, wherein the shield case includes a hall sensor on its inner upper surface corresponding to the magnet in the optical axis direction, the hall sensor detecting displacement in a direction perpendicular to the optical axis direction.

18. The camera lens module of claim 11, wherein the edge portion is bent upwardly in the optical axis direction.

19. The camera lens module of claim 11, wherein the edge portion is bent downwardly in the optical axis direction.
